(19) United States
(12) Patent Application Publication
(10) Pub. No.: US 2012/0016671 A1
(43) Pub. Date: Jan. 19, 2012

(54) Tool and method for enhanced human machine collaboration for rapid and accurate transcriptions

(76) Inventors: Pawan Jaggi, Plano, TX (US); Abhijeet Sangwan, Allen, TX (US)

(21) Appl. No.: 12/804,159

(22) Filed: Jul. 15, 2010

(51) Int. Cl. G10L 15/26

(52) U.S. Cl. 704/235; 704/E15.043

(57) ABSTRACT

A system and methods for transcribing text from audio and video files including a set of transcription hosts and an automatic speech recognition system. ASR word-lattices are dynamically selected from either a text box or word-lattice graph wherein the most probable text sequences are presented to the transcriptionist. Secure transcriptions may be accomplished by segmenting a digital audio file into a set of audio slices for transcription by a plurality of transcriptionist. No one transcriptionist is aware of the final transcribed text, only small portions of transcribed text. Secure and high quality transcriptions may be accomplished by segmenting a digital audio file into a set of audio slices, sending them serially to a set of transcriptionists and updating the acoustic and language models at each step to improve the word-lattice accuracy.

### FIELD OF THE INVENTION

The present invention relates to systems and methods for creating a transcription of spoken words obtained from audio recordings, video recordings or live events such as a courtroom proceeding.

### BACKGROUND OF THE INVENTION

Transcription refers to the process of creating text documents from audio/video recordings of dictation, meetings, talks, speeches, broadcast shows etc. The utility and quality of transcriptions is measured by two metrics: (i) Accuracy, and (ii) Turn-around time. Transcription accuracy is measured in word error rate (WER), which is the percentage of the total words in the document that are incorrectly transcribed. On the other hand, turn-around time refers to the time-taken to generate the text transcription of an audio document. While accuracy is necessary to maintain the quality of the transcribed document, the turn-around time ensures that the transcription is useful for end application. Transcriptions of audio/video documents can be obtained by three means: (i) Human transcriptionists, (ii) Automatic Speech Recognition (ASR) technology, and (iii) Combination of Human and Automatic Techniques.

The human based technique involves a transcriptionist listening to the audio document and typing the contents to create a transcription document. While it is possible to obtain high accuracy with this approach, it is still very time-consuming. Several factors make this process difficult and contribute to the slow speed of the process:

(i) Differences in listening and typing speed: Typical speaking rates of 200 words per minute (wpm) are far greater than average typing speeds of 40-60 wpm. As a result, the transcriptionist must continuously pause the audio/video playback while typing to keep the listening and typing operations synchronized.

(ii) Background Noise: Noisy recordings often force transcriptionists to replay sections of the audio multiple times which slows down transcription creation.

(iii) Accents/Dialects: Foreign accented speech causes cognitive difficulties for the transcriptionist. This may also result in repeated playbacks of the recording in order to capture all the words correctly.

(iv) Multiple Speakers: Audio recordings that have multiple speakers also increases the complexity of the transcription task.

(v) Human Fatigue Factor: Transcribing long audio/video files requires many hours of continuous concentration. This leads to increased human errors and/or time-taken to finish the task.

A number of tools (hardware and software) have been developed to improve human-efficiency. For example, the foot-pedal enabled audio controller which allows the transcriptionist to control audio/video playback with their feet and frees up their hands for typing. Additionally, transcriptionists are provided comprehensive software packages which integrate communication (FTP/email), audio/video control, and text editing tools into a single software suite. This allows transcriptionists to manage their workflow from a single piece of software. While these developments make the transcriptionist more efficient, the overall process of creating transcripts is still limited by human abilities.

Advancements in speech recognition and processing technology offers an alternative approach towards transcription creation. ASR (automatic speech recognition) technology offers a means of automatically converting audio streams into text, and thereby speed-up the process of transcription generation. ASR technology works especially well in restricted domains and small-vocabulary tasks but degrades rapidly with increasing variability such as large vocabulary, diverse speaking-styles, diverse accents/dialects, environmental noise etc. In summary, human-based transcripts are accurate but slow; while machine-based transcripts are fast but inaccurate.

One possible manner of simultaneously improving accuracy and speed of transcription would be to combine human and machine capabilities into a single efficient process. For example, a straight-forward approach is to provide the machine output to the transcriptionist for editing and correction. However, it is argued that this is not efficient as the transcriptionist is now required to perform three instead of two tasks simultaneously. These three tasks are (i) listening to the audio, (ii) reading machine-generated transcripts, and (iii) editing (typing/deleting/navigating) to prepare the final transcript. On the other hand, in a purely human-based approach, the transcriptionist only listens and types (no simultaneous reading is required). Additionally, as editing is different from typing at a cognitive level, a steep learning curve is required for the existing man-power to develop this new expertise. Finally, it is also possible at high WERs the process of editing machine generated transcripts might be more time-consuming than creating human-based transcripts.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block diagram of a first embodiment of a system for rapid and accurate transcription of spoken language.

FIG. 2 is a block diagram of a second embodiment of a system for rapid and accurate transcription of spoken language.

FIG. 3 is a diagram of an apparatus for combined typing and playback for transcription efficiency.

FIG. 4 is a diagram of an apparatus for synchronized typing and playback for transcription efficiency.

FIG. 5 is an exemplary graphical representation of an ASR word lattice presented to a transcriptionist.

FIG. 6 is a diagram of a method for engaging a relevant ASR word lattice for transcription.

FIG. 7 is a flowchart of a method for rapidly and accurately transcribing a continuous stream of spoken language.

FIG. 8 is a diagram describing a first transcription process based on visual interaction with an ASR lattice combined with typed character input.

FIG. 9 is a diagram describing a second transcription process based on visual interaction with an ASR lattice combined with typed word input.

FIG. 10 is a diagram describing a third transcription process based on visual interaction with an ASR lattice combined with word history input.

FIG. 11 is a combination flow diagram showing a transcription process utilizing a predicted utterance and key actions to accept text.

FIG. 12 is a block diagram of a transcription process incorporating dynamically supervised adaptation of acoustic and language models to improve transcription efficiency.

FIG. 13A illustrates a method of maintaining confidentiality of a document during transcription using a plurality of transcriptionists.

FIG. 13B is a block diagram of a first embodiment transcription apparatus utilizing a plurality of transcriptionists.

FIG. 13C is a block diagram of a second embodiment transcription apparatus utilizing two transcriptionists.

FIG. 14A illustrates a method of maintaining quality of a document during transcription using a plurality of transcriptionists.

FIG. 14B is a block diagram of a networked transcription apparatus utilizing a plurality of transcription system hosts.

FIG. 15 is a serialized transcription process for maintaining confidentiality and quality of transcription documents during transcription using a plurality of transcriptionists.

### DETAILED DESCRIPTION

The proposed invention provides a novel transcription system for integrating machine and human effort towards transcription creation. The following embodiments utilize output ASR word lattices to assist transcriptionists in preparing the text document. The transcription system exploits the transcriptionists input in the form of typing keystrokes to select the best hypothesis in the ASR word lattice, and prompt the transcriptionist with the option of auto-completing a portion or the remainder of the utterance by selecting graphical elements by mouse or touchscreen interaction, or by selecting hotkeys. In searching for the best hypothesis, the current invention utilizes the transcriptionist input, ASR word timing, acoustic, and language model scores. From a transcriptionist's perspective, their experience includes typing a part of an utterance (sentence/word), reading the prompted alternatives for auto-completion, and then selecting the correct alternative. In the event that none of the prompted alternatives are correct, the transcriptionist continues typing, and this process provides new information for generating better alternatives from the ASR word lattice, and the whole cycle repeats. The details of this operation are explained below.

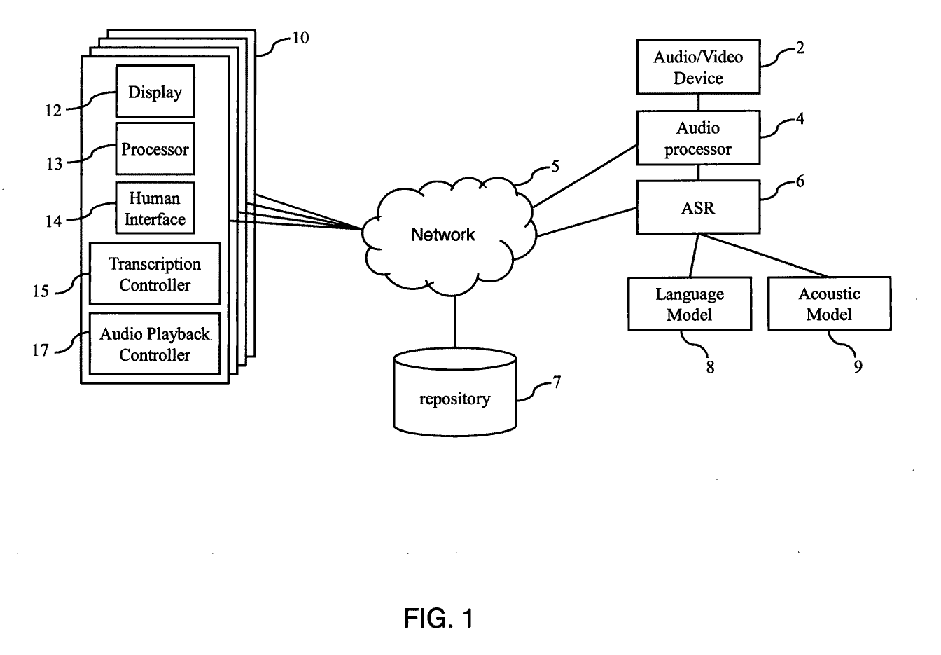

FIG. 1 shows a diagram of a first embodiment of the transcription system. Audio data streams, or a combination of audio and video data streams are created by audio/video recording devices 2 and stored as digital audio files for further processing. The digital audio files may be stored locally in the audio/video recording devices or stored remotely in an audio repository 7 connected to the audio processor by a digital network 5. The transcription system comprises an audio processor 4 for converting the digital audio files into a converted audio data suitable for processing by an automatic speech recognition module, ASR module 6. The converted audio data may be, for example, a collection of audio slices for utterances separated by periods of detected silence in the audio data stream. The converted audio data is stored locally or in the audio repository 7.

ASR module 6 further comprises an acoustic model 9 and a language model 8. Acoustic model 8 is a means of generating probabilities P(O|W) representing the probabilities of observing a set of acoustic features, O in an utterance, for a sequence of words, W. Language model 9 is a means of generating probabilities P(W) of occurrence of the sequence of words W, given a training corpus of words, phrases and grammars in various contexts. W, which is typically a trigram of words but may be a bigram or n-gram in general, represents word-history. The acoustic model will take into account speakers' voice characteristics, such as accent, as well as background noise and environmental factors. ASR module 6 functions to produce text output in form of ASR word lattices. Alternatively, word-meshes, N-best lists or other lattice-derivatives may also be generated for the same task. ASR word lattices are essentially word-graphs that contain multiple alternative hypotheses of what was spoken during a particular time period. Typically, the word error rates (WERs) of ASR word lattices are much better than a single best-hypothesis.

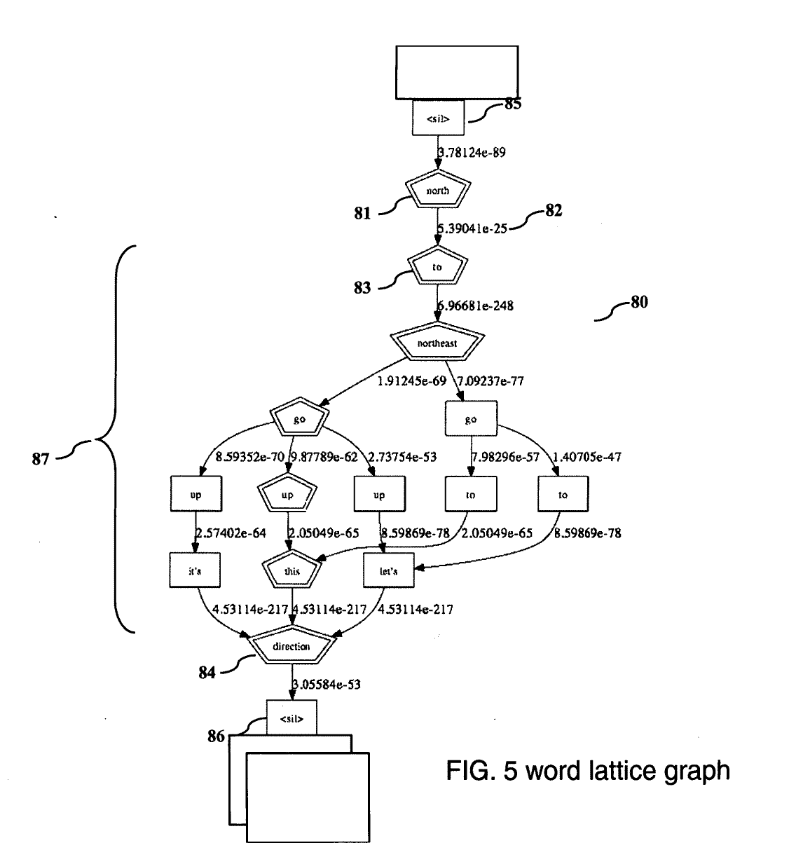

An example ASR word lattice is shown in FIG. 5, the ASR word lattice 80 beginning with a first silence interval 85 and ending with a second silence interval 86 and having a first word 81, a second word 83 and a last word 84 and a set of possible intermediate words 87. Probabilities are shown between the various words, including probability 82 which is proportional to the probability P(W)P(O|W) where W represents word-history including at least first word 81 and second word 83, and O describes the features of the spoken audio.

Returning to a discussion of FIG. 1, the transcription system includes a set of transcription system hosts 10 each of which comprises components including a processor 13, a display 12, at least one human interface 14, a transcription controller 15, and an audio playback controller 17. Each transcription system host is connected to digital network 5 and thereby in communication with audio repository 7 and ASR module 6.

Audio playback controller 17 is configured to play digital audio files according to operator control via human interface 14. Alternatively, audio playback controller 17 may be configured to observe transcription speed and operate to govern the playback of digital audio files accordingly.

Transcription controller 15 is configured to operate accept input from an operator via human interface 14, for example, typed characters, typed words, pressed hotkeys, mouse events, and touchscreen events. Transcription controller 15, through the network communications with audio repository 7 and ASR module 6, is further configured to operate the ASR module to obtain or update ASR word lattices, n-grams, N-best words and so forth.

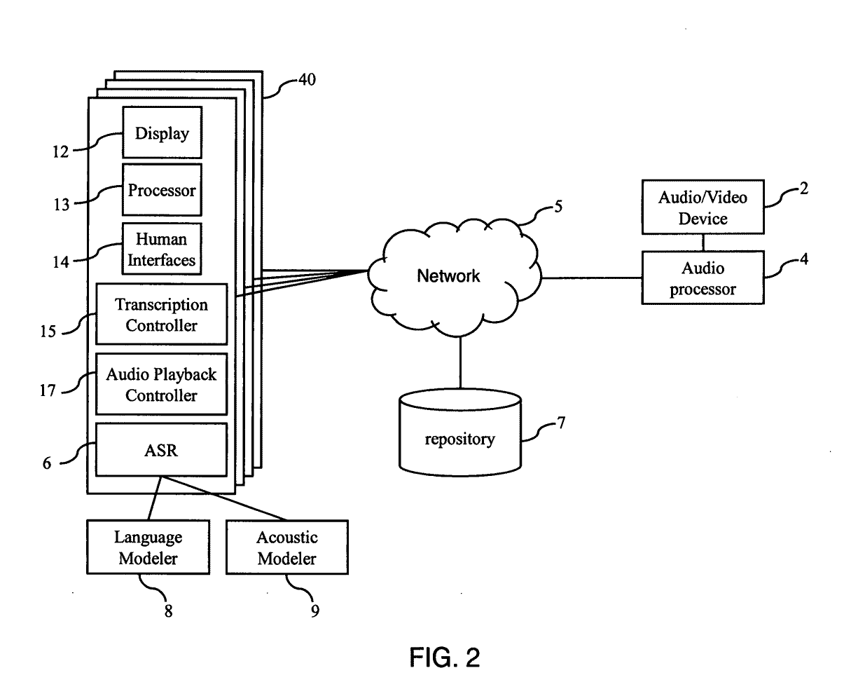

FIG. 2 is a diagram of a second embodiment of a transcription system wherein an ASR module 6 is incorporated into each of the set of transcription system hosts 10. The transcription system of FIG. 2 is similar to that of FIG. 1, having the audio/video device 2, audio processor 4, audio repository 7 and a set of transcription system hosts 10 connected to digital network 5 and wherein each transcription system host is in communications with at least audio repository 7. In the second embodiment, ASR module 6 comprises language model 8 and acoustic model 9 as before. Each transcription system host in the set of transcription system hosts 10 comprises a display 12, a processor 13, a human interface 14, a transcription controller 15 and an audio playback controller 17, configured substantially the same as the transcription system of FIG. 1.

Many other transcription equipment configurations may be perceived in the context of the present invention. In one such example, the digital audio file may exist locally on a transcription system host while the ASR module is available by network, say over the internet. As a transcriptionist operates the transcription system host to transcribe digital audio/video content, audio segments may be sent to a remote ASR module for processing, the ASR module returning a text file describing the ASR word lattice.

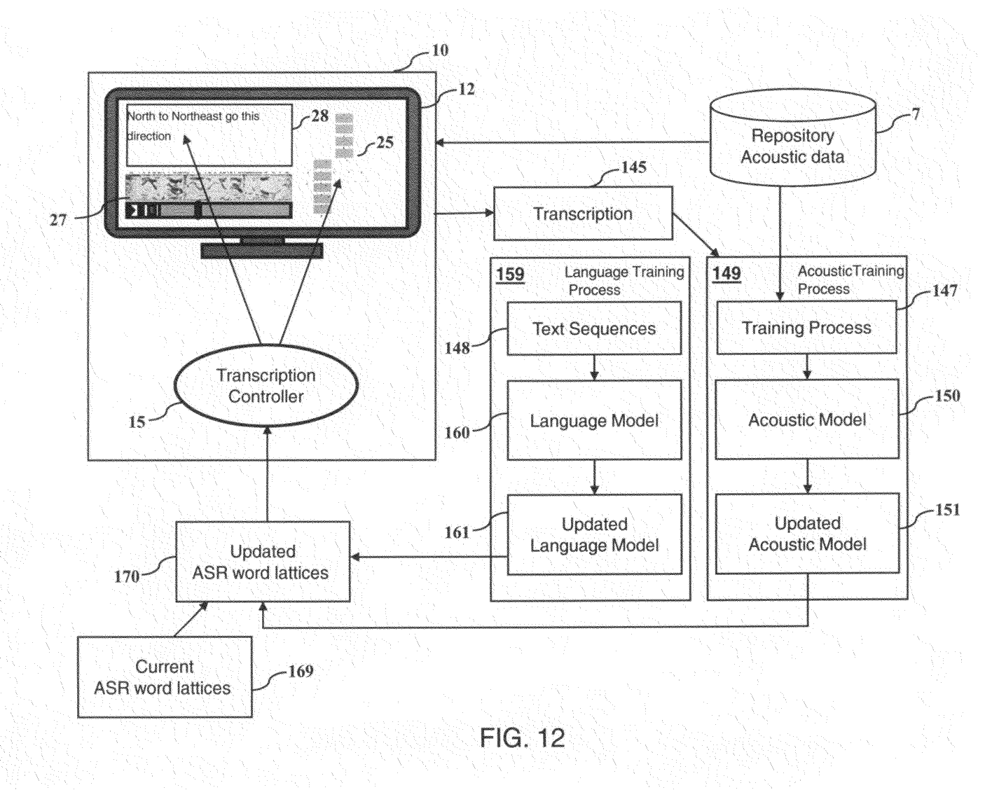

In another example of a transcription system host configuration, one transcription system host is configured to operate as a master transcription controller while the other transcription system hosts in the set of transcription system hosts are configured to operate as clients to the master transcription controller, each client connected to the master transcription controller over the network. In operation, the master transcription controller segments a digital audio file into audio slices, sends audio slices to each transcription system host for processing into transcribed text slices, receives the transcribed text slices and appropriately combines the transcribed text slices into a transcribed text document. Such a master transcription controller configuration is useful for the embodiments described in relation to FIGS. 12A, 12B, 12C, 13A, 13B and 14.

Suitable devices for the set of transcription system hosts may include, but are not limited to, desktop computers, laptop computers, a personal digital assistant (PDA), a cellular telephone, a smart phone (e.g. a web-enabled cellular telephone capable of operating independent apps), a terminal computer, such as a desktop computer connected to and interacting with a transcription web application operated by a web server, a dedicated transcription device comprising the transcription system host device components from FIG. 2. The transcription system hosts may have peripheral devices for human interface, for example, a foot pedal, a computer mouse, a keyboard, a voice controlled input device and a touchscreen.

Suitable audio repositories include database servers, file servers, tape streamers, networked audio controllers, network attached storage devices, locally attached storage devices, and other data storage means that are common in the art of information technology.

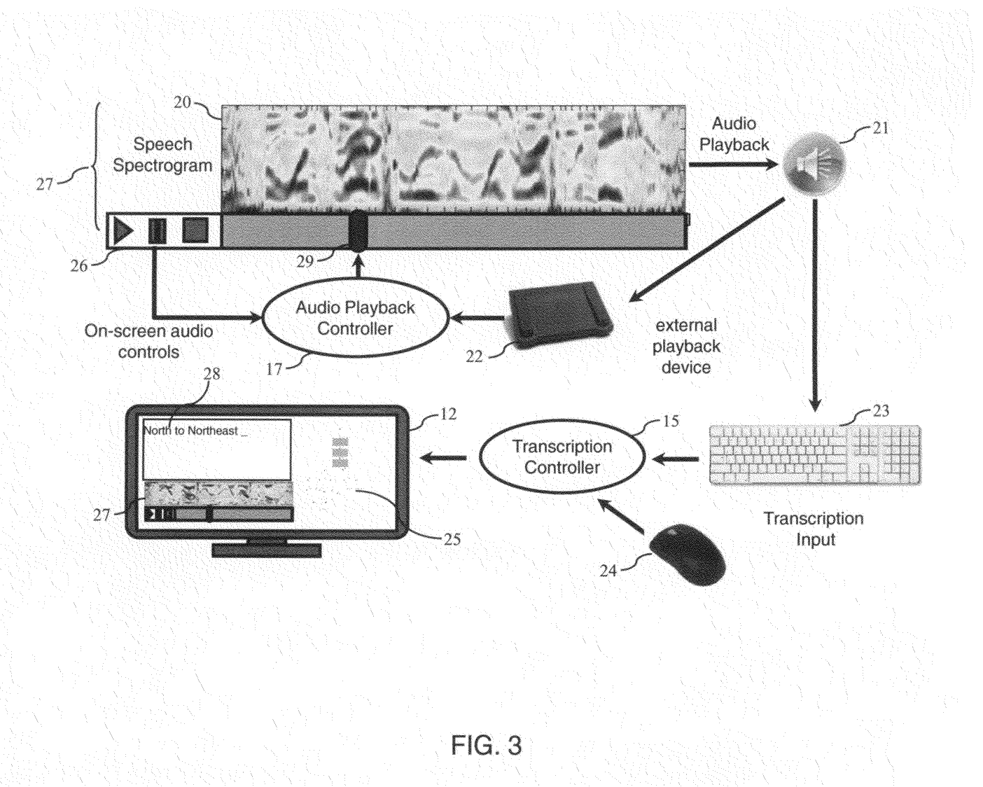

FIG. 3 is a diagram showing a transcription system host configuration which combines operator input with automatic speech recognition using transcription system host components. Display 12 comprises a set of objects including acoustic information tool 27, textual prompt and input screen 28, and a graphical ASR word lattice 25 which aid the operator in the transcription process. Acoustic information tool 27 is expanded to show that it contains a speech spectrogram 20 (or alternatively, a speech waveform) and a set of on screen audio controls 26 that interact with audio playback controller 17 including audio file position indicator 29. Human interfaces include speaker 21 for playing the audio sounds, a keyboard 23 for typing, a mouse 24 for selecting object features within display 12, and an external playback control device 22, which may be a foot pedal as shown. Audio playback controller 17 controls the speed, audio file position, volume, and accepts input from external playback control device 22 as well as the set of on-screen audio controls 26. Transcription controller 15 accepts input from textual prompt and input screen 28 via keyboard 23 and from graphical ASR word lattice 25 via mouse 24. Keyboard 23 and mouse 24 are used to select menu items displayed in display 12 including n-word selections in textual prompt and input screen 28. Alternatively, display 12 may be a touchscreen device that incorporates a similar selection capability as mouse 24.

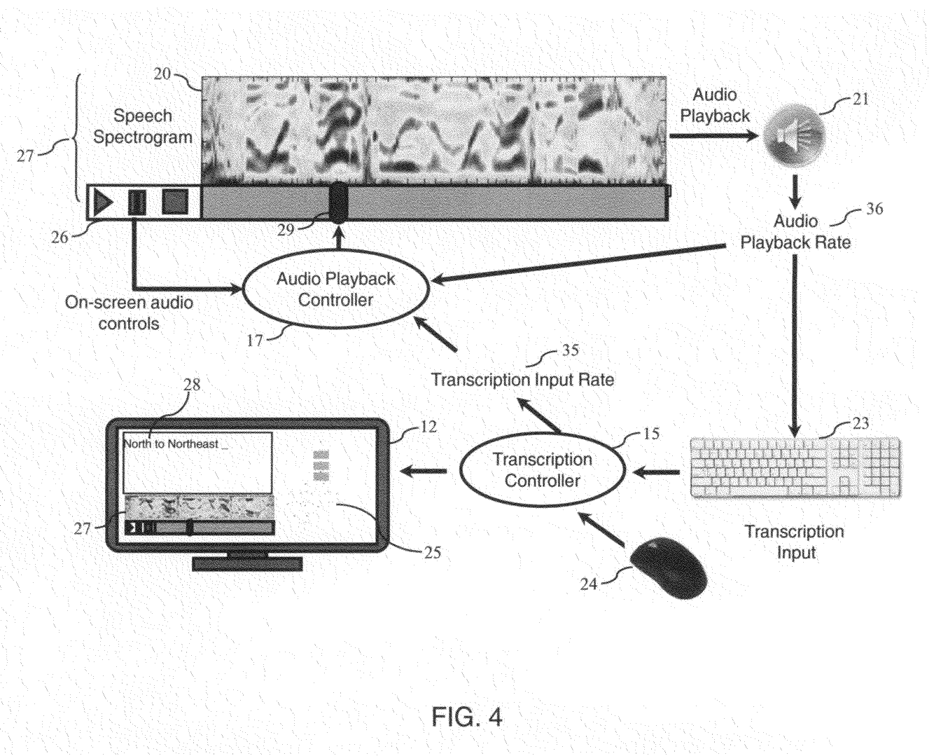

FIG. 4 is a diagram showing a preferred transcription system host configuration which synchronizes operator input with automatic speech recognition using transcription system host components. Display 12 comprises a set of objects including acoustic information tool 27, textual prompt and input screen 28, and a graphical ASR word lattice 25 which aid the operator in the transcription process. Acoustic information tool 27 is expanded to show that it contains a speech spectrogram 20 and a set of on screen audio controls 26 that interact with audio playback controller 17 including audio file position indicator 29. Human interfaces include speaker 21 for playing the audio sounds, a keyboard 23 for typing, a mouse 24 for selecting object features within display 12. Transcription controller 15 accepts input from textual prompt and input screen 28 via keyboard 23 and from graphical ASR word lattice 25 via mouse 24. Keyboard 23 and mouse 24 are used to select menu items displayed in display 12 including n-word selections in textual prompt and input screen 28. Transcription controller 15 communicates transcription rate 35 to audio playback controller 17 which is programmed to automatically control the speed, audio file position, volume, and accept further rate related input from the set of on-screen audio controls 26 as needed while governing audio playback rate 36. Audio play back controller 17 operates to optimize the transcription input rate 35.

In a preferred embodiment, the audio playback rate is dynamically manipulated on the listening side, while matching rate manipulations to typing rate to provide the auto control of audio settings. This reduces the time it takes to adjust various audio controls for optimal operator performance. Such a dynamic playback rate control minimize the use of external controls like audio buttons and foot pedals which are most common in transcriber tools available in the art today. Additionally, use of mouse clicks, keyboard hot keys and so forth are minimized.

Similarly, in another embodiment, background noise is dynamically adjusted by using speech enhancement algorithms within the ASR module so that the playback audio is more intelligible for the transcriptionist.

The graphical ASR word lattice 25 indicated in FIGS. 3 and 4 is similar to the ASR word lattice example of FIG. 5.

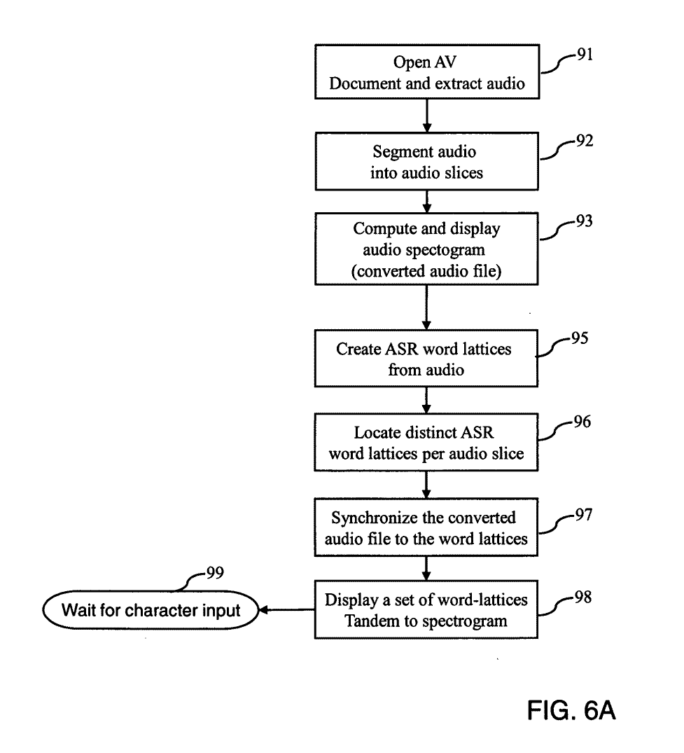

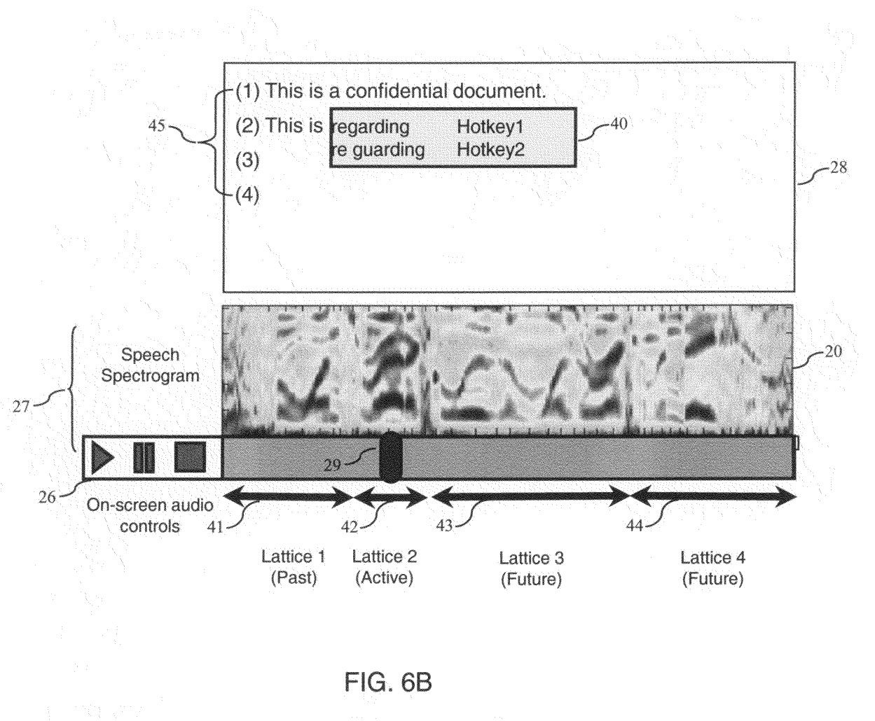

An exemplary transcription process shown in FIG. 6A initiates with the opening of an audio/video document for transcription (step 91). The digital audio data portion of the audio/video document is analyzed and split into time segments usually related to pauses or changes in speaker, changes in speaker intonation, and so forth (step 92). The time segments can be obtained through the process of automatic audio/video segmentation or by using any other available meta-information. A spectrogram or waveform is optionally computed as a converted audio file and displayed (step 93). The ASR module then produces a universe of ASR word lattices for the digital audio data before a transcriptionist initiates his/her own work (step 95). The universe of ASR word lattices may be produced remotely on a remote speech recognition server or locally via the transcriptionist's machine or as per FIGS. 1 and 2, respectively. The universe of ASR word lattices are the ASR module's hypothesis of what words were spoken within the digital audio file or portions therein. By segmenting the universe of ASR word lattices, the transcription system is capable of knowing which ASR word lattices should be engaged at what point of time. The transcription system uses the time segment information of the audio/video segmentation in the digital audio file to segment at least one available ASR word lattice for each time segment (step 96). Once a set of available ASR word lattices are computed, and the digital audio file and converted audio file is synchronized with the available ASR word lattices (step 97), the system then displays a first available word lattice in synchronization with the displayed spectrogram (step 98, and as shown in FIG. 6B), and waits for the transcriptionist's input (step 99).

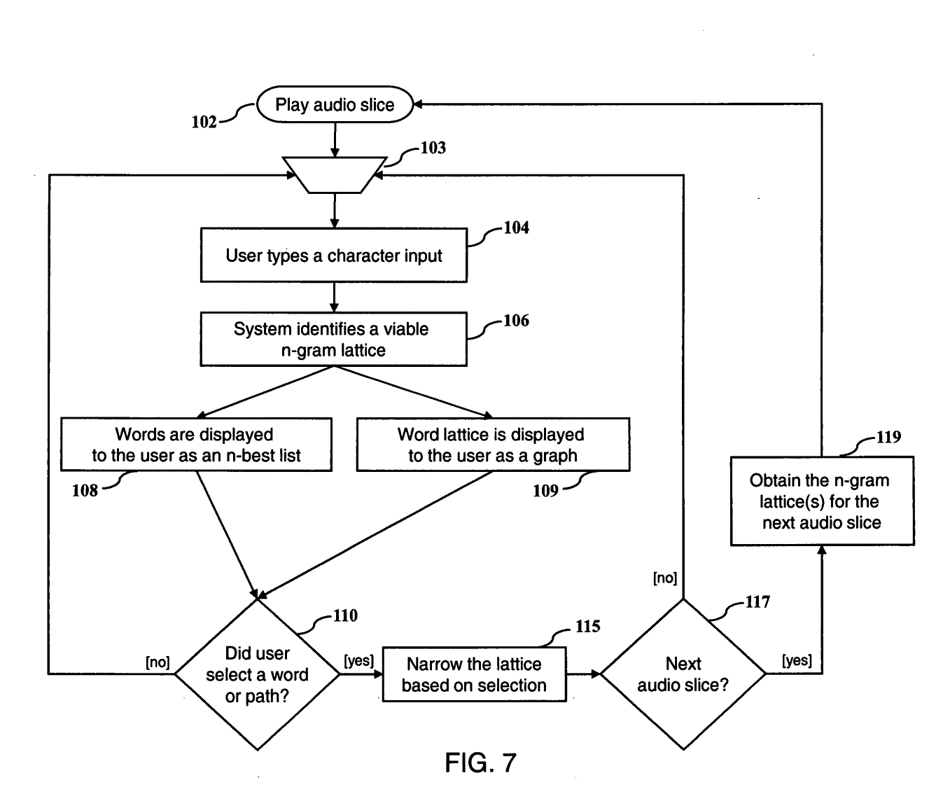

A transcription is performed according to the diagram of FIG. 6B and the transcription method of FIG. 7. In FIG. 6B, the acoustic information tool 27 including speech spectrogram 20 and set of on-screen audio controls 26 along with textual prompt and input screen 28 is displayed to the transcriptionist. At this point the transcriptionist begins the process of preparing the document with audio/video playback (listening) and typing. From the timing information of audio/video playback, indicated by position indicator 29, the system determines which ASR word lattice word should be engaged. FIG. 6B shows segments of audio: audio slice 41, audio slice 42, audio slice 43 and audio slice 44, corresponding to Lattice 1, Lattice 2, Lattice 3 and Lattice 4, respectively. Audio slice 42 with Lattice 2 is engaged and represents the utterance which is actively being transcribed according to position indicator 29, audio slice 41 represents an utterance played in the past and audio slices 43 and 44 are future utterances which have yet to be transcribed. The transcriptionist's key-inputs 45 are utilized in choosing the best paths (or sub-paths) in the ASR word lattice as shown in a pop-up prompt list 40. It is noted that each line in the transcription 45 corresponds to one of audio slices 41, 42, 43, 44 which in turn corresponds to an ASR word lattice.

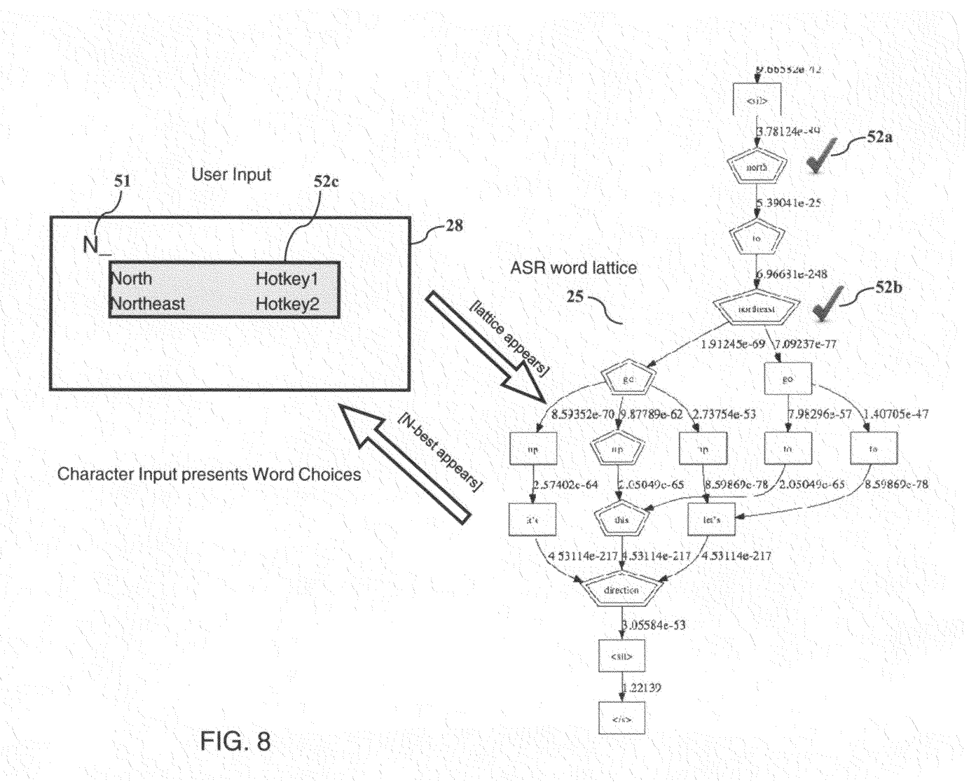

Moving to the method of FIG. 7, as soon as the transcriptionist plays the first audio segment in step 102 and enters the first character of a word in step 104, all words starting with that character within the ASR word lattice are identified in step 106 and prompted to the user as word choices in step 108 as a prompt list and in step 109 as graphic prompt. In step 108, the LM (language model) probabilities of these words are used to rank the words in the prompt list which is displayed to the transcriptionist. In step 109 the LM probabilities of these words and subsequent words are displayed to the transcriptionist in a graphical ASR word lattice as shown in FIG. 8 and explained further below. At this point, the transcriptionist either chooses an available word or types out the word if none of the alternatives were acceptable. Step 110 identifies whether the transcriptionist selected an available word or phrase of words. If an available word or a phrase of words was not selected, then the transcription system awaits more input via step 103. If an available word or a phrase of words was selected, then LM probabilities from the ASR word lattices are recomputed in step 115 and presented as a new list of candidate word sequences. Longer word histories (trigrams and n-grams in general) are available in from step 115 as the transcriptionist types/chooses more words thereby providing the ability to make increasingly intelligent word choices for subsequent prompts. Thus, the transcriptionist can also be prompted with n-gram word-sequence alternatives rather than just single-word alternatives. Furthermore, the timing information of words in the lattice is utilized to further prune and re-rank the choice of word(s) alternatives prompted to the transcriptionist. For example, if the transcriptionist is typing at the beginning of an utterance then words occurring at the end-of-utterance in the lattice are less likely and vice-versa. In this manner, the timing, acoustic, and language scores are all used to draw up the list of alternatives for the transcriptionist. Step 115 effectively narrows the ASR word sequence hypotheses for the audio segment by keeping the selected portions and ruling out word sequence hypotheses eliminated by those selections.

Continuing with step 117, after the ASR word lattice is recomputed, the transcription system ascertains if the audio segment has been completely transcribed. If not, then the transcription system awaits further input via step 103.

If the audio segment has been completely transcribed in step 117, then the transcription system moves to the next (new) audio segment, configuring a new ASR word lattice for the new audio segment in step 119, plays the new audio segment in step 102 and awaits further input via step 103.

The transcription method is further illustrated in FIGS. 8, 9 and 10. Beginning with FIG. 8, textual prompt and input screen 28 is shown along with graphical ASR word lattice 25 to illustrate how typed character input presents word choices to the transcriptionist. The transcriptionist has as entered an “N” 51 and the transcription system has selected the words in the lattice and displayed it with checkmarks 52a and 52b alongside “north” and “northeast”, respectively as the two best choices that match the transcriptionist's input. Also, prompt box 52c is displayed showing “north” and “northeast” with associated hotkey assignments, “hotkey1” and “hotkey2”, which, for example, could be the “F1” and “F2” keys on a computer keyboard or a “1” and a “2” on a cellular phone keyboard. Transcriptionist may then select the correct word (a) on the graphical ASR word lattice 25 using a mouse or touchscreen, or (b) in the textual prompt and input screen by pressing one of the hotkeys.

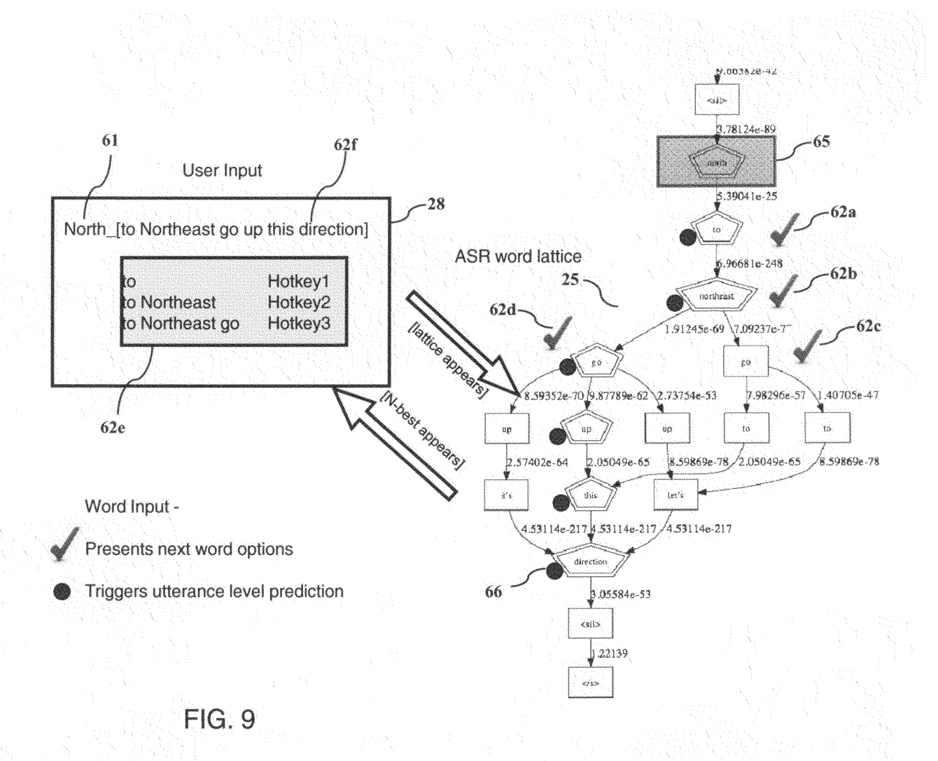

Alternatively, the transcriptionist may continue typing. FIG. 9 indicates such a scenario, wherein typed word input presents multiple word choices. The transcriptionist has now typed out “North” 61. This action positively identifies “north” 65 in the ASR word lattice by shading in a block around the word. Furthermore, a new set of checkmarks, 62a-62d appear respectively beside the words “to”, “northeast”, “go” on the right branch, and “go” on the left branch. Also, prompt box 62e is displayed showing “to”, “to northeast” and “to northeast go” with associated hotkey assignments, “hotkey1”, “hotkey2” and “hotkey3”. The transcriptionist may then select (a) the correct words on the graphical ASR word lattice 25 using a mouse or touchscreen, or (b) the correct phrase in the textual prompt and input screen 28 by hitting one of the hotkeys. Where there is no ambiguity, choosing a correct word on the graphical ASR word lattice 25, may select a phrase. For example, choosing “go” on the left branch may automatically select the parent branch “to northeast”, thereby selecting “to northeast go” and furthermore identifying the correct “go” with the left branch.

In an alternative embodiment of word input, the transcriptionist typed input is utilized to automatically discover the best hypothesis for the entire utterance so that an utterance-level prediction 62f is generated and displayed in the textual prompt and input screen 28. As the transcriptionist continues to provide more input the utterance-level prediction is refined and improved. If the utterance level prediction is correct, the transcriptionist can select entire utterance level prediction 62f by entering an appropriate key or mouse event (such as pressing return key on the keyboard). To enable the utterance-level prediction operation, algorithms such as Viterbi decoding can be utilized to discover the best partial path in the ASR word lattice conditioned on the transcriptionist's input. To further alert the transcriptionist to the utterance level prediction, a set of marks 66 in word lattice graph 25 may be used to locate the set of words in the utterance level prediction (shown as circles in FIG. 9). Alternatively, accentuated lines may be drawn around word boxes associated to the set of words or the specially colored boxes may designate the set of words.

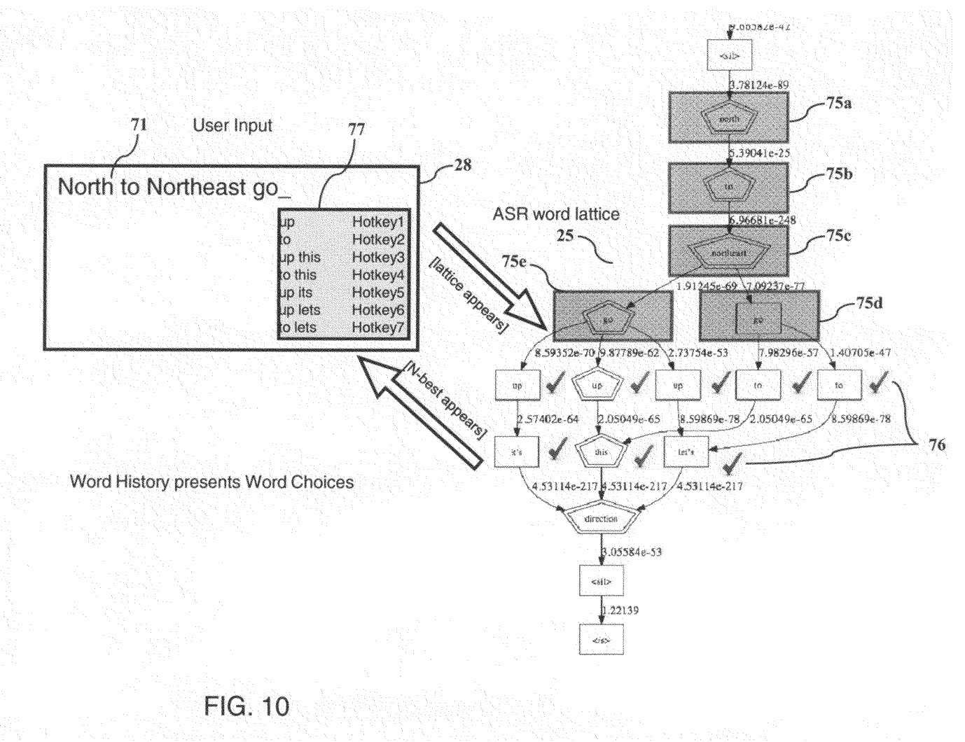

The process may continue as in FIG. 10 wherein word history presents multiple word choices. The transcriptionist has now typed or selected “North to Northeast go” 71. This action positively identifies the word sequence (phrase) “north” 75a, “to” 75b, “northeast” 75c, “go” 75d, and “go” 75e in the graphical ASR word lattice 25 by shading in blocks around the words. Furthermore, another new set of checkmarks 76 appear respectively beside the words “up”, “to”, “it's”, “this”, and “let's” on various lattice paths. According to the graphical ASR word lattice 25, “go” has been selected in an ambiguous way, not identifying the right or left branch. Since “go” is ambiguous all of the words on the right and left branches are available to be chosen and appear with a new set of checkmarks 76 or appear in the prompt list box 77 associated to various hotkeys. The transcriptionist may then select (a) the correct phrase on the graphical ASR word lattice 25 using a mouse or touchscreen, or (b) the correct phrase in the textual prompt and input screen 28 by pressing one of the hotkeys. Alternatively, a voice activated event may be defined for input, such as “Lattice A”, that will select the corresponding phrase.

Where there is no ambiguity, choosing a correct word on the graphical ASR word lattice 25, may select a phrase. In a first example, choosing “this” on the left branch will not automatically select the left branch, but will limit the possible phrases to “north to northeast go up this direction”, and “north to northeast go to this direction” which would appear in the prompt box or the graphical ASR word lattice as the next possible phrase choice. In a second example, choosing any of the “up” boxes limits the next possible choice to the left branch thereby allowing the next choices to be “north to northeast go up it's direction”, “north to northeast go up this direction”, and “north to northeast go up let's direction”.

The transcription system may cause some paths to be highlighted differently depending upon the probabilities as in utterance level prediction. Using the example of FIG. 10, the language model in the ASR module would likely calculate “go up let's direction” as much less probable than “go up it's direction” which may be less probable than “go up it's direction”. Based on this assumption, the transcription system: will not highlight the “go up let's direction” path; will highlight the “go up it's direction” path with yellow; and will highlight the “go up this direction” with green. Alternatively, accentuated lines may be drawn around boxes or different colored marks may be assigned to words.

The transcription method utilizes an n-gram LM for predicting the next item in subsequence of n characters used in a given utterance. An n-gram of size 1 (one) is referred to as a “unigram”; size 2 (two) is a “bigram”; size 3 (three) is a “trigram” and size 4 (four) or more is simply called an “n-gram”. The corresponding probabilities are calculated as

P(Wi)·P(Wⱼ|Wᵢ)·P(Wₖ|Wⱼ,Wᵢ)

for a trigram as an example. When the first character is typed the transcription method exploits unigram knowledge (as in FIG. 8). When a word is given, the transcription method exploits bigram knowledge (as in FIG. 9). When a phrase including only one word is given, the transcription method exploits n-gram knowledge to an order which gives maximum efficiency for transcription completion (as in FIG. 10). Entire sentence hypotheses may be predicted based on n-gram knowledge.

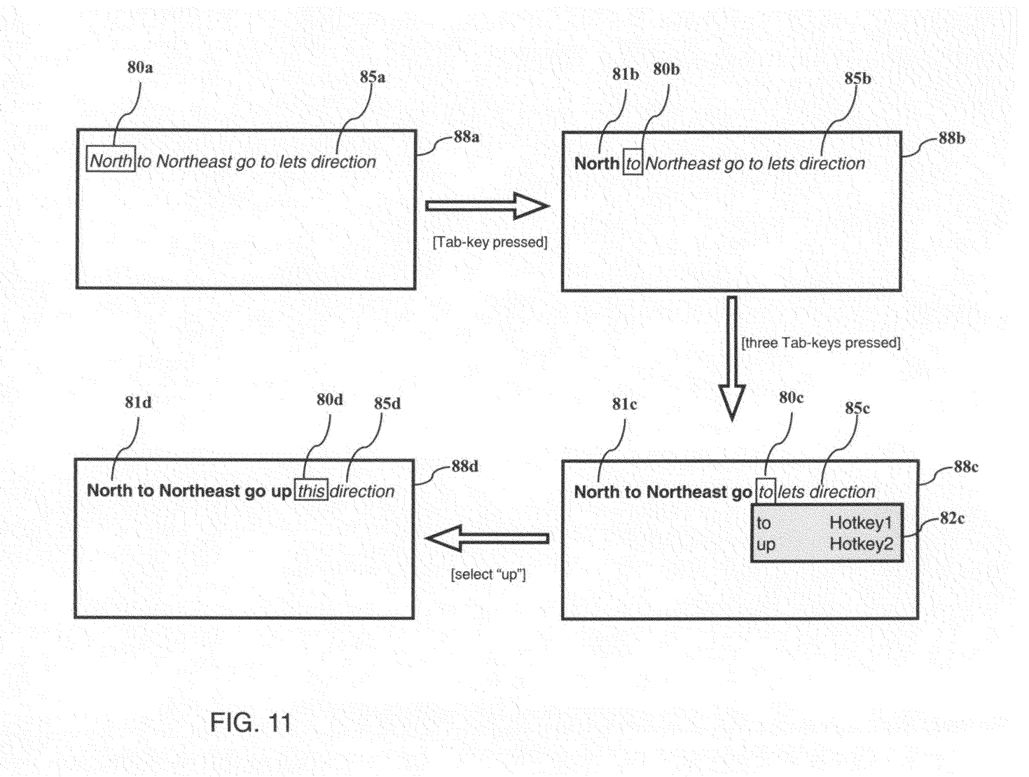

In relation to the utterance level prediction, word and sentence hypothesis aspect of the present invention, a tabbed-navigation browsing technique is provided to a transcriptionist to parse through predicted text quickly and efficiently. Tabbed-navigation is explained in FIG. 11. At first, the transcriptionist is presented with the best utterance-level prediction 85a from the ASR lattice on a first input screen 88a. In a preferred embodiment, the predicted utterance is displayed in a different font-type (and/or font-size) from the transcriptionist's typed words in order to enable the transcriptionist to easily identify typed and accepted material from automatically predicted material. Initially, a cursor is automatically positioned on the first word of the predicted utterance depicted by box 80a wherein the current word associated with the cursor position is highlighted to enable fast editing in case the transcriptionist needs to change the word at the current cursor position. After this, the transcriptionist can either edit the current word by typing or jump to the next word by a pre-defined key action such as pressing the tab-key. Jumping to the next word requires pressing the tab-key once. This key action automatically changes the first input screen to a second input screen 88b moving the cursor position from 80a to 80b and updating the following words to predicted utterance 85b. At the same time, the font type of the previous word 81b is changed to indicate that this word has been typed or accepted.

Similarly, a set of key actions such as three tab-key presses, automatically changes the second input screen 88b to a third input screen 88c moving the cursor position from 80b to 80c and updating the following words to predicted utterance 85c. At the same time, the font type of the previous words 81c are changed to indicate that the previous words have been typed or accepted.

Whenever the transcriptionist inputs changes to any word in the predicted utterance, the predicted utterance is updated to reflect the best hypothesis based on new transcriptionist input. For example, as shown in third input screen 88c, the transcriptionist selects the second option in prompt list box 82c which causes “to” to be replaced by “up”. This action triggers updating of the predictions and leads to new predicted utterance 85d which is displayed in a fourth input screen 88d along with the updated cursor position 80d and the accepted words 81d.

Knowledge of the starting and ending time of an utterance, derived from the digital audio file, are exploited by the transcription method to exclude some hypothesized n-grams. Knowledge of the end word in an utterance may be exploited to converge to a best choice for every word in a given utterance. In general, the transcription method as described, allows the transcriptionist to either type the words or choose from a list of alternatives while continuously moving forward in time throughout the transcription process. High-quality ASR output would imply that the transcriptionist mostly chooses words and types less throughout the document. Alternatively, very poor ASR output would imply that the transcriptionist utilizes typing for most of the document. It may be noted that the latter case also represents the current procedure that transcriptionists employ when ASR output in not available to them. Thus, in theory, the transcription system described herein can never take more time than human-only-transcriptionists and can be many times faster than current procedure while maintaining high levels of accuracy throughout the document.

In another aspect of the present invention, adaptation techniques are employed to allow a transcription process to improve acoustic and language models within the ASR module. The result is a dynamic system that improves as the transcription document is produced. In the present state of art, this adaptation is done by physically transferring language and acoustic models gathered separately after completing the entire document and then feeding that information statically to the ASR module to improve performance. In such systems a part of the document completion cannot assist in improving the efficiency and quality of the remaining document.

FIG. 12 is a block diagram of such a dynamic supervisory adaptation method. As before a transcription system host 10 has a display 12, a graphical ASR word lattice 25, a textual prompt and input screen 28, an acoustic information tool 27, and a transcription controller 15. Transcription system host 10 is connected to a repository of audio data 7 to collect a digital audio file. A transcriptionist operates transcription system host 10 to transcribe the digital audio file into a transcription document (not shown). During the process of transcribing, an ASR module (not shown) is engaged to present word lattice choices to the transcriptionist. The transcriptionist makes selections within the choices to arrive at a transcription. At the beginning of the transcription process the ASR module is likely to be using general acoustic and language models to arrive at the ASR word lattice for a given set of audio segments, the acoustic and language models having been previously trained on audio that may be different in character than the given set of audio segments. The WER at the beginning of a transcription will correlate to this difference in character. Thereafter, the dynamic supervisory adaptation process is engaged to improve the WER.

Once a first transcription 145 is completed on the digital audio file by typing or making selections in display 12, the first transcription is associated to the current ASR word lattices 169 and to the completed digital audio segment and fed back to the ASR module to retrain it. An acoustic training process 149 matches the acoustic features 147 in the current acoustic model 150 to the first transcription 145 to arrive at an updated acoustic model 151. Similarly, a language training process 159 matches the language features 148 in the current language model 160 to the first transcription 145 to arrive at an updated language model 161. The ASR module updates the current ASR word lattices 169 to updated ASR lattices 170 which are sent to the transcription controller 17. Updated ASR lattices 170 are then engaged as the transcription process continues.

Dynamic supervisory adaptation works within the transcription process to compensate for artifacts like noise and speaker traits (accents, dialects) by adjusting the acoustic model and to compensate for language context such as topical context, conversational styles, dictation, and so forth by adjusting the language model adaptation. This methodology also offers a means of handling out-of-vocabulary (OOV) words. OOV words such as proper names, abbreviations etc. are detected within the transcripts already generated so far and included in task vocabulary. Now, yet to be seen lattices for the same audio document can be regenerated using the new vocabulary, acoustic, and language models. In an alternate embodiment, the OOV words can be stored as a bag-of-words. When displaying word-choices to users from the lattice based on keystrokes, words from the OOV bag-of words are also considered and presented as alternatives.

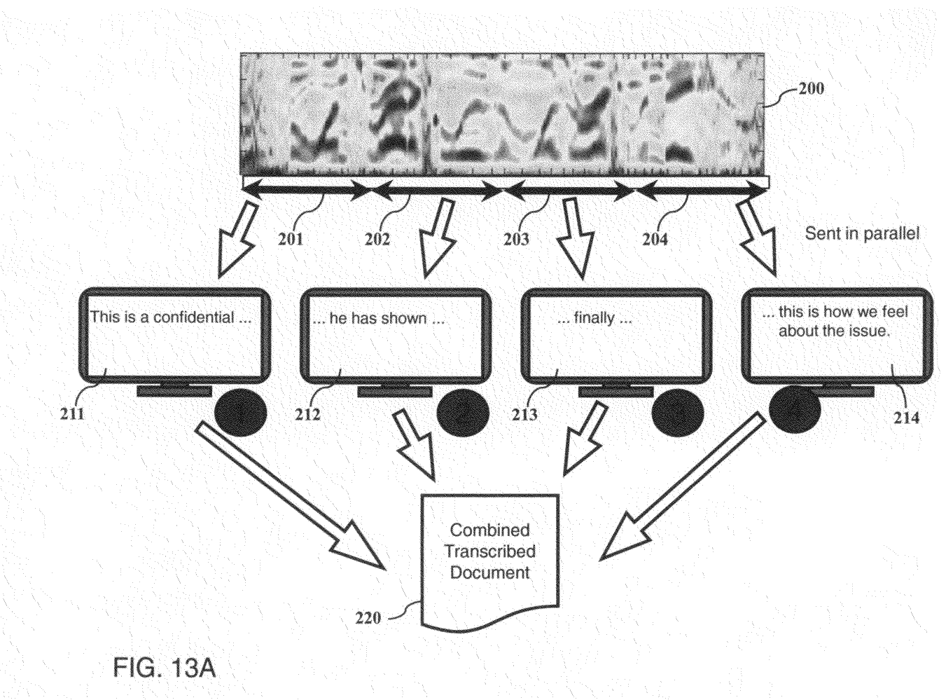

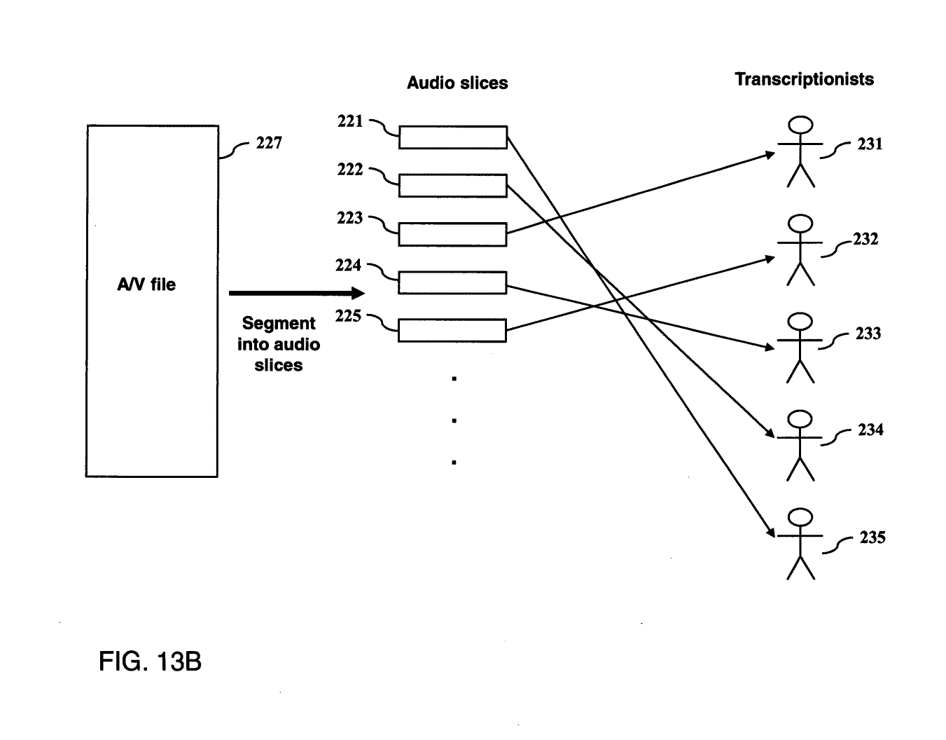

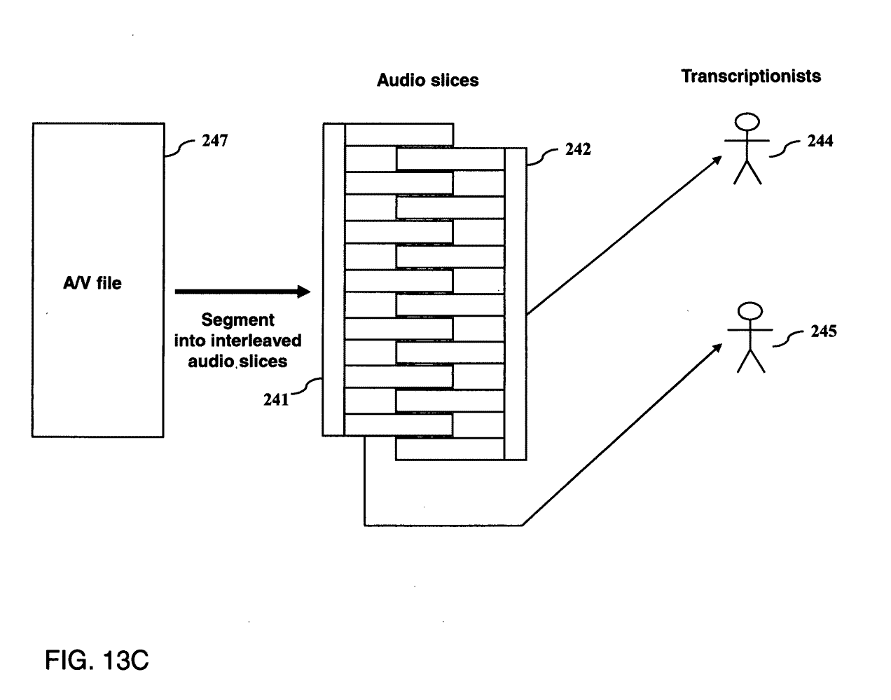

In a first embodiment process for transcription of confidential information, multiple transcription system hosts are utilized to transcribe a single digital audio file while maintaining confidentiality of the final complete transcription. FIGS. 13A, 13B and 13C illustrate the confidential transcription method. A digital audio file 200 represented as a spectrogram in FIG. 13A is segmented into a set of audio slices designated by audio slice 201, audio slice 202, audio slice 203 and audio slice 204 by a transcription controller. Audio slices 201-204 may be distinct from each other or they may contain some overlapping audio. Each slice in the set of audio slices is sent to a different transcriptionist, each transcriptionist producing a transcript of the slice sent to them: transcript 211 of audio slice 201, transcript 212 of audio slice 202, transcript 213 of audio slice 203 and transcript 214 of audio slice 204. The transcripts are created using the method and apparatus as described in relation to FIGS. 1-11. Once the transcripts are completed, they are combined together by the transcript controller into a single combined transcript document 220.

In one aspect of the process for transcription of confidential information, transcription system hosts may be mobile devices including PDAs and mobile cellular phones which operate transcription system host programs. In FIG. 13B, a digital audio/video file 227 is segmented into audio slices 221, 222, 223, 224, 225 and so on. Audio slices 221-225 are sent to transcriptionists 231-235 by a transcription controller as indicated by the arrows. Each transcriptionist may perform a transcription of their respective audio segment and relay each resulting transcript back to the transcription controller using email means, FTP means, web-browser upload means or similar file transfer means. The transcription controller then combines the transcripts into a single combined transcript document.

In FIG. 13C, a second embodiment of a confidential transcription process is shown wherein there is a limited number of transcriptionists available. The digital audio/video file 247 may be split into two files, a first file 241 containing a first group of audio slices with time segments of audio missing between them and a second file 242 containing a second group of audio slices containing the missing time slices of audio. First file 241 is sent to a first transcriptionist 244 and second file 242 is sent to a second transcriptionist, 245. Each transcriptionist may perform a transcription on their respective audio slice and relay each resulting transcript back to the transcription controller using email means, FTP means, web-browser upload means or similar file transfer means. The transcription controller then combines the transcripts into a single combined transcript document. The transcription remains confidential as no one transcriptionist has enough information to construct the complete transcript.

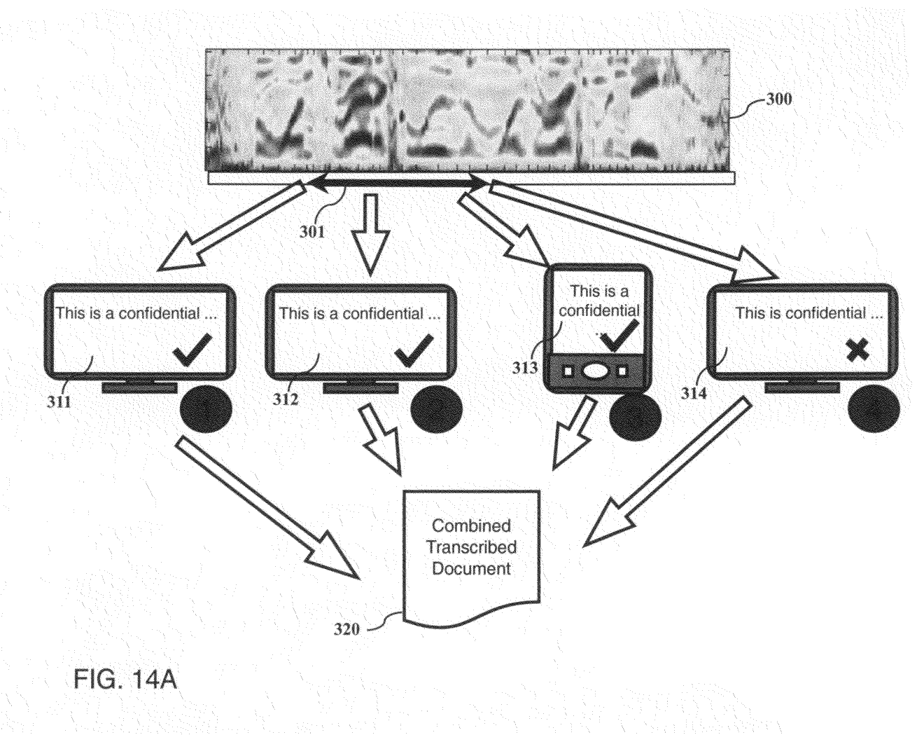

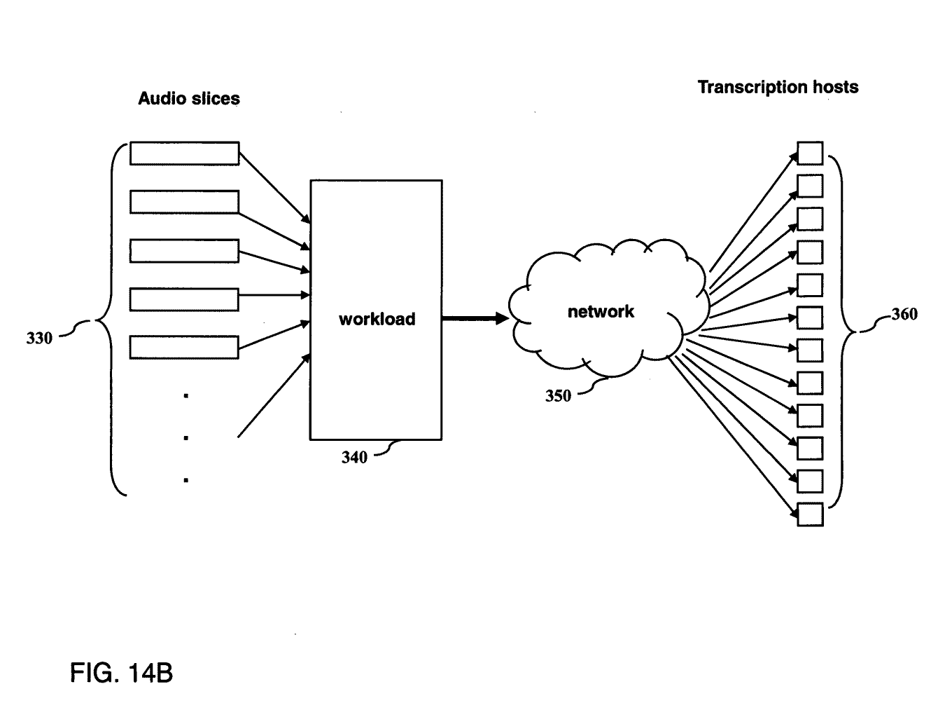

In a first embodiment quality controlled transcription process, multiple transcription system hosts are utilized to transcribe a single digital audio file in order to produce a high quality complete transcription. FIGS. 14A and 14B illustrate the quality controlled transcription method. A portion of a digital audio file 300 represented as a spectrogram in FIG. 14A is segmented, thereby producing an audio slice designated by audio slice 301. For example, this may be a particularly difficult segment of the digital audio file to transcribe and prone to high WER. Multiple copies of audio slice 301 are sent to a set of transcriptionists, each transcriptionist producing a set of transcripts of the audio slice 301: transcript 311, transcript 312, transcript 313 and transcript 314. The set of transcripts are created using the method and apparatus as described in relation to FIGS. 1-11 and 13B. Once the transcripts in the set of transcripts are completed, they are combined together by the transcript controller into a single combined transcribed document 320.

The selection of transcribed words for the combined transcribed document may be made based on counting the number of occurrences of a transcribed word in the set of transcripts and selecting the word with the highest count. Alternatively, the selection may include a correlation process: correlating the set of transcripts by computing a correlation coefficient for each word in the set of transcripts, assigning a weight to each word based on the WER of transcriptions, scoring each word by mulitiplying the correlation coefficients and the weights and selecting the word transcriptions with the highest score for inclusion in the single combined transcript document. Thereby, the first embodiment quality controlled transcription process performs a quality improvement on the transcription document.

FIG. 14B illustrates some scaling aspects of the quality controlled transcription process. A workload may be created for quality control by combining a set of audio slice 330 from a group of digital audio files into audio workload file 340 which is subsequently sent to a set of transcriptionists 360 via a network 350, the network being selected from the group of the internet, a mobile phone network and a combination thereof. The transcriptionists may utilize PDAs or smart mobile phones to accomplish the transcriptions utilizing the transcription system and methods of FIGS. 1-12 and send in their transcriptions for quality control according to the method of FIG. 14A.

In another aspect of the quality controlled transcription process, the method of the first embodiment quality controlled transcription process is followed, except that the transcriptionists are scored based on aggregating the word transcription scores from their associated transcripts. The transcriptionists with the lowest scores may be disqualified from participating in further transcribing, resulting in a quality improvement in transcriptionist capabilities.

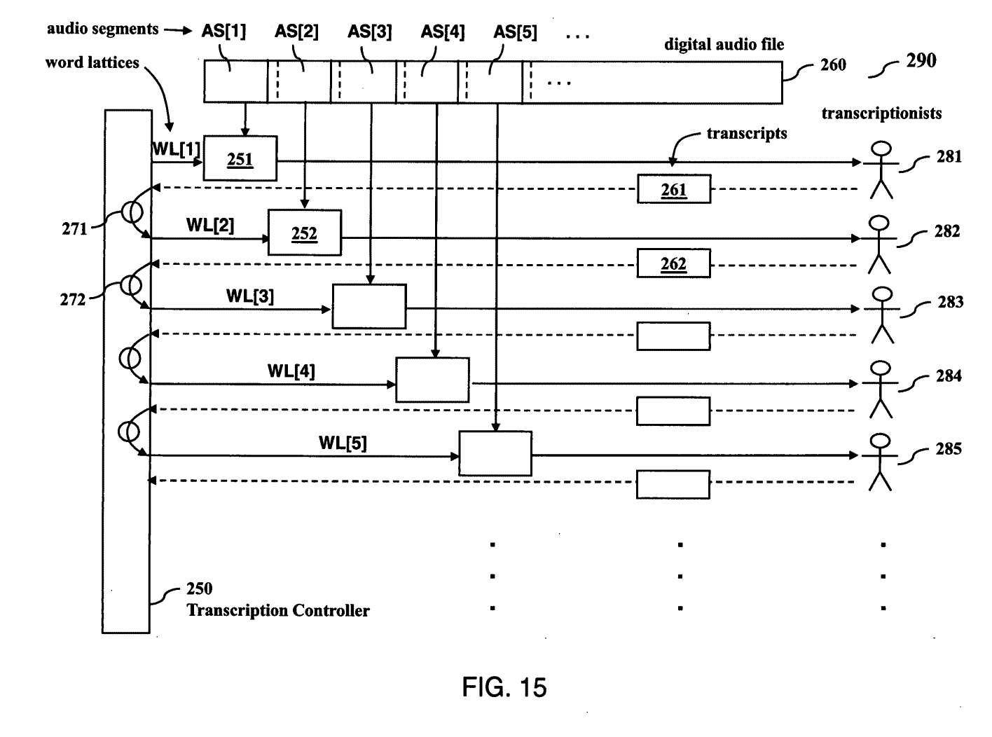

Confidentiality and quality may be accomplished in an embodiment of a dynamically adjusted confidential transcription process shown in FIG. 15. Process 290 is a serial process wherein a complete transcription of a digital audio file is accomplished by multiple transcriptionists, one audio segment at a time and combined into the complete transcription at the end of the process. Confidentiality is maintained since no one transcriptionist sees the complete transcription. Furthermore a quality control step may be implemented between transcription events so as to improve the transcription process as it proceeds. Process 290 requires a transcription controller 250 and a digital audio file 260. Transcription controller 250 parses the digital audio file into audio segments AS[1]-AS[5] wherein the audio segments may overlap in time. ASR word lattice WL[1] from an ASR module is combined with the first audio segment AS[1] to form a transcription package 251 which is sent by the transcription controller to a remote transcriptionist 281 via a network. Remote transcriptionist 281 performs a transcription of the audio segment AS[1] and sends it back to the transcription controller via the network as transcript 261. Once received, transcription controller 250 processes transcript 261, in step 271, using the ASR module to update the ASR acoustic model, the ASR language model and update the ASR word lattice as WL[2].

The updated word lattice WL[2] module is combined with audio segment AS[2] to form a transcription package 252 which is sent by the transcription controller to a remote transcriptionist 282 via a network. Remote transcriptionist 282 performs a transcription of the audio segment AS[2] and sends it back to the transcription controller via the network as transcript 262. Once received, transcription controller 250 processes transcript 262, in step 272, using the ASR module to update the ASR acoustic model, the ASR language model and update the ASR word lattice as WL[3]. Transcript 262 is appended to transcript 261 to arrive at a current transcription.

The step of combining an updated word lattice with an audio segment, sending the combined package to a transcriptionist, transcribing the combined package and updating the word lattice is repeated for additional transcriptionists 283, 284, 285 and others, transcribing ASR word lattices WL[3], WL[4], WL[5], . . . associated to the remaining audio segments AS[3], AS[4], AS[5], . . . until the digital audio file is exhausted and a complete transcription is performed. The resulting product is of high quality as the word lattice has been continuously updated to reflect the language and acoustic features of the digital audio file. Furthermore the resulting product is confidential with respect to the transcriptionists. Yet another advantage of process 290 is that an ASR word lattice is optimized for similar type digital audio files—optimized in regards to not only matching the acoustic and language models, but optimized across variations in transcriptionists. Put another way, the resulting ASR word lattice at the end of process 290 has removed transcriptionist bias that might occur during training of the acoustic and language models.

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

1. A transcription system for transcribing a set of audio data into transcribed text comprising:
an audio processor configured to convert the set of audio data to segment the audio data into a first set of audio segments;
the audio processor configured to store the set of audio segments in an audio repository;
a set of transcription hosts connected to a network, each transcription host of the set of transcription hosts in communication with an acoustic speech recognition system, the audio processor and the audio repository, wherein each transcription host of the set of transcription hosts comprises:
a processor,
a display,
a set of human interface devices,
an audio playback controller, and
a transcription controller;
wherein the acoustic speech recognition system is configured to operate on the audio data to produce a first set of word lattices;
wherein the audio playback controller of each transcription host is configurable to audibly playback the set of audio segments;
wherein the transcription controller of each transcription host in the set of transcription hosts is configured to:
retrieve a second set of audio segments from the first set of audio segments and a second set of word lattices from the first set of word lattices;
associate a first word lattice from the second set of word lattices with a first audio segment from the second set of audio segments;
associate a second word lattice from the second set of word lattices with a second audio segment from the second set of audio segments;
display a graphical representation of the first word lattice and second word lattice; and
accept an operator input via the set of human interface devices to confirm at least one word of the first word lattice as transcribed text.

2. The transcription system of claim 1 wherein the set of transcription hosts are selected from the group of a desktop computer, a laptop computer, a personal digital assistant (PDA), a cellular telephone, a web-enabled communications device, a transcription server serving a transcription host application over the internet to a web-enabled client, and a dedicated transcription device.

3. The transcription system of claim 1 wherein each transcription controller in the set of transcription hosts is further configured:
to display the first word lattice and the second word lattice in a textual form in a text input area; and
to allow for selection of at least one word from the first word lattice and the second word lattice.

4. The transcription system of claim 1 wherein the audio playback controller is connected to at least one human interface device of the set of human interface devices.

5. The transcription system of claim 1 wherein the transcription host is configured so that the audio playback controller and the transcription controller are synchronized to establish an audio playback rate in response to a transcription input rate.

6. The transcription system of claim 1 wherein the transcription controller, in displaying the graphical representation of the first word lattice and second word lattice, is further configured to display a set of connecting lines between words in a pre-defined number of most probable text sequences.

7. The transcription system of claim 1 wherein the transcription controller, in displaying the graphic representation of the first word lattice and second word lattice, is further configured to:
a. establish a set of probabilities of occurrence for a predefined number of most probable text sequences contained in a word lattice; and
b. display a probability indicator of a set of likely text sequences.

8. The transcription system of claim 7 where the most probable text sequences are comprised of an ordered set of words; and where, the probability indicator is selected from a group including a number, a graphic indicator beside each word in the ordered set of words, an object containing each word in the ordered set of words, a line connecting each word in the ordered set of words.

9. The probability indicator of claim 8 wherein the graphic indicator is assigned a color based on a probability of occurrence.

10. The probability indicator of claim 8 wherein the graphic indicator is assigned a shape based on a probability of occurrence.

11. The transcription system of claim 1 wherein at least one transcription host in the set of transcription hosts is a master transcription controller serving a set of transcription applications over a network to the other transcription hosts in the set of transcription hosts.

12. The transcription system of claim 11 wherein the master transcription controller is enabled to control distribution of audio segments and word-lattices to the other transcription hosts in the set of transcription hosts.

13. The transcription system of claim 1 wherein each transcription host in the set of transcription hosts further comprises an acoustic speech recognition system.

14. A method for transcription of audio data into transcribed text by a transcription host including an audio playback controller and a transcription controller, a display and a set of human interface devices, the method including the steps of:
providing audio controls in the audio playback controller to play the audio data at an audio playback rate;
converting the audio data into a visual audio format;
segmenting the audio data into a set of audio segments;
operating on the audio data with an automatic speech recognition system to arrive at a set of word lattices;
correlating a first word lattice in the set of word lattices to a first audio segment in the set of audio segments;
correlating a second word lattice in the set of word lattices to a second audio segment in the set of audio segments;
displaying a portion of converted audio data associated to the first and second audio segment in the visual audio format;
displaying a graphic of the first word lattice on the display as a graphical word lattice;
configuring a textual input box to show the first word lattice and to capture a textual input from a human interface device;
playing the first audio segment using the audio playback controller;
performing a transcription input;
controlling the audio playback rate;
repeating the transcription input step for the first word lattice until a text sequence is accepted as transcribed text;
displaying a graphic of the second word lattice on the display as the graphical word lattice;
configuring the textual input box to show the second word lattice and to capture a textual input from a human interface device;
playing the second audio segment using the audio playback controller;
repeating the transcription input step for the second word lattice until a text sequence is accepted as and appended to the transcribed text.

15. The method of claim 14 wherein the step of performing a transcription input comprises selecting a word or a phrase from the graphical word lattice using a human interface device connected to the transcription controller.

16. The method of claim 14 wherein the step of performing a transcription input comprises typing a character and selecting a word or phrase in the textual input box.

17. The method of claim 14 including the steps of:
analyzing an average transcription input rate from the repeated transcription input steps;
controlling the audio playback rate automatically based on the average transcription input rate.

18. A method for performing transcriptions of audio data into transcribed text utilizing a transcription host device having a display, and wherein the audio data is segmented into a set of audio slices, the method including the steps of:
a. determining a universe of ASR word-lattices for the audio data;
b. associating an available ASR word-lattice in the universe of ASR word-lattices with an audio slice in the set of audio slices;
c. playing an audio slice from the set of audio slices;
d. upon a textual input of at least one character, identifying a set of viable text sequences from the available ASR word-lattice;
e. displaying the set of viable text sequences as an N-best list;
f. displaying the available ASR word lattice as a graph;
g. waiting for at least one of the group of a word selection from the N-best list, a text sequence selection within the graph, and a typed character;
h. if a typed character occurs, repeating the preceding steps beginning with the step of identifying a set of viable text sequences;
i. if a word selection occurs or a text sequence selection occurs, narrow the set of viable text sequences based on the word or text sequence selection;
j. if the audio slice has not been fully transcribed then repeating steps g-h; and
k. if the audio slice is fully transcribed, obtaining a next audio slice in the set of audio slices and repeating steps b-j with the next audio slice.

19. The method of claim 18 including the steps of:
establishing a set of probabilities of occurrence for a predefined number of most probable text sequences contained the available ASR word lattice; and
displaying a probability indicator of the most probable text sequences.

20. The method of claim 18 wherein the step of displaying a probability indicator includes the step of:
identifying a text sequence path with a number.

21. A method for secure transcription of a digital audio file into a transcribed text document comprising the steps of:
providing a first transcription host to a first transcriptionist, wherein the first transcription host is equipped with a first automatic speech recognition system;
providing a second transcription host to a second transcriptionist, wherein the second transcription host is equipped with a second automatic speech recognition system;
providing a master transcription controller in communication with the first and second transcription hosts;
segmenting the digital audio file into a first set of audio slices and a second set of audio slices;
sending the first set of audio slices from the master transcription controller to the first transcriptionist;
sending the second set of audio slices from the master transcription controller to the second transcriptionist;
the first transcriptionist transcribing the first set of audio slices using the first transcription host into a first transcribed text;
the second transcriptionist transcribing the second set of audio slices using the second transcription host into a second transcribed text;
the first and second transcriptionist sending the first and second transcribed texts to the master transcription controller; and
the master transcription controller combining the first transcribed text and the second transcribed text into a final transcribed text as the digital audio file.

22. The method of claim 21 wherein the step of segmenting the digital audio file further comprises the steps of:
segmenting the digital audio file according to a series of time intervals wherein each time interval is subsequent to the previous time interval;
assigning the first time interval in the series of time intervals as a current time interval;
creating a first audio slice recorded during the current time interval;
creating a second audio slice recorded during the next time interval immediately subsequent to the first time interval;
including the first audio slice in the first set of audio slices;
including the second audio slice in the second set of audio slices; and
repeating the preceding steps starting with the step of creating a first audio slice, for the entire series of time intervals.

23. The method of claim 22 wherein the step of segmenting the digital audio file further comprises the steps of:
segmenting the digital audio file according to a series of time intervals wherein each time interval partially overlaps with the previous time interval;
assigning the first time interval in the series of time intervals as a current time interval;
creating a first audio slice recorded during a current time interval;
creating a second audio slice recorded during the next time interval in the series of time intervals following, but overlapping with the current time interval;
including the first audio slice in the first set of audio slices;
including the second audio slice in the second set of audio slices; and
repeating the preceding steps starting with the step of creating a first audio slice, for the entire series of time intervals.

24. The method of claim 23 wherein the step of segmenting the digital audio file further comprises the steps of:
segmenting the digital audio file according to a series of time intervals wherein each time interval is subsequent to the previous time interval;
assigning the first time interval in the series of time intervals as a current time interval;
creating a current audio slice recorded during the current time interval;
including the current audio slice in the first set of audio slices;
including the current audio slice in the second set of audio slices; and
repeating the preceding steps starting with the step of creating a first audio slice, for the entire series of time intervals.

25. The method of claim 24 including the further step of the master controller comparing the first transcribed text to the second transcribed text to assess the quality of at least one of the group of the first transcribed text, the second transcribed text, and the final transcribed text.

26. The method of claim 24 including the further steps of:
associating an accurate text to the digital audio file; and
comparing the first transcribed text and the second transcribed text to the accurate text to assess the quality of transcription by at least one of the first transcriptionist and the second transcriptionist.

27. A method for secure and accurate transcription of a digital audio file into a transcribed text document comprising the steps of:
providing a set of transcription hosts to a set of transcriptionists comprising at least three transcriptionists, wherein each transcription host in the set of transcription hosts is equipped with an automatic speech recognition system;
providing a master transcription controller in communication with the set of transcription hosts;
segmenting the digital audio file into at least three sets of audio slices,
distributing each set of audio slices from the master transcription controller to each transcriptionist in the set of transcriptionists;
the set of transcriptionist transcribing the at least three sets of audio slices into at least three transcribed texts;
the set of transcriptionists sending the at least three transcribed texts to the master transcription controller; and
the master transcription controller combining the at least three transcribed texts into a final transcribed text for the digital audio file.

28. The method of claim 27 wherein the step of segmenting the digital audio file includes the additional step of ensuring that audio slices comprising each set of audio slices are not associated to consecutive recorded time intervals in the digital audio file.

29. The method of claim 27 wherein the step of segmenting the digital audio file includes the additional step of constructing each set of audio slices from audio slices associated to random recorded time intervals in the digital audio file.

30. The method of claim 27 including the additional step of assessing the accuracy of the transcribed text by counting the number of matching words in the at least three transcribed texts.

31. The method of claim 27 including the additional step of assessing the accuracy of the transcribed text further comprising the steps of:
computing a correlation coefficient for each word in the at least three transcribed texts;
assigning a weight to each word in the at least three transcribed texts;
deriving a set of scores containing one score for each word in the at least three transcribed texts, by multiplying the weight by the correlation coefficient; and,
selecting a set of words for inclusion in the final transcribed text based on the set of scores.
